(19) United States
(12) Patent Application Publication
(10) Pub. No.: US 2020/0031032 A1
(43) Pub. Date: Jan. 30, 2020

(54) Method for Producing a Rotor Unit

(71) Applicant: SCHUNK KOHLENSTOFFTECHNIK GMBH, Heuchelheim (DE)

(72) Inventors: Tobias Bittendorf, Wettenberg (DE); Michael Weik, Wettenberg (DE)

(21) Appl. No.: 16/522,963

(22) Filed: Jul. 26, 2019

(30) Foreign Application Priority Data
Jul. 30, 2018 (DE) 10 2018 118 341.0

(51) Int. Cl. B29C 45/14; B29C 45/02; F04D 29/18; F04D 29/046

(52) U.S. Cl. CPC B29C 45/14; B29C 45/02; B29L 2031/7498; F04D 29/046; F04D 29/18

(57) ABSTRACT

The invention pertains to a method for producing a rotor unit or a bearing unit, wherein the rotor unit or bearing unit is respectively realized with a rotor or a bearing housing and a plain bearing bush (20) for the rotatable arrangement of the rotor on a spindle, wherein the plain bearing bush is placed into a mould (21), wherein the rotor or the bearing housing is respectively produced by attaching a polymeric material to the plain bearing bush in the mould by means of a transfer moulding process or injection moulding process, wherein the plain bearing bush is composed of a first bush section (25) and a second bush section (26) that is connected to the first bush section, wherein the bush sections are placed into the mould, and wherein the polymeric material is attached to the bush sections.

The disclosure of German Patent Application No. 10 2018 118 341.0, filed Jul. 30, 2018, is incorporated herein by reference.

### TECHNICAL FIELD

The invention pertains to a method for producing a rotor unit or a bearing unit, as well as to a respective rotor unit or bearing unit, wherein the rotor unit is realized with a rotor and a plain bearing bush for the rotatable arrangement of the rotor on a spindle, wherein the plain bearing bush is placed into a mould, and wherein the rotor is produced by attaching a polymeric material to the plain bearing bush in the mould by means of a transfer moulding process or injection moulding process.

### BACKGROUND

Rotor units of polymeric materials are sufficiently known from the prior art and typically used as a component of a canned motor or a pump, e.g. with an impeller formed on the rotor unit, in heating circuits or in vehicles. In canned motors, a rotor unit and a stator of the electric motor are separated by a can, which is arranged in an air gap between the stator and the rotor unit. This makes it possible to hermetically separate the rotor unit from the stationary components of the pump without the use of seals. In this case, the rotor unit is driven in a brushless manner, i.e. with a permanently magnetic or separately excited armature of the rotor unit. The rotor and the plain bearing bush are bathed in the medium to be conveyed in the pump, wherein a pump wheel or an impeller is respectively arranged on one end of the rotor. A tribological pairing of the spindle and the plain bearing bush is subject to strict requirements in order to ensure a long service life of the pump. Depending on the medium to be conveyed, dirt particles in a bearing gap of the spindle or roughening of a bearing surface of the spindle due to corrosion can lead to increased wear of the spindle or the plain bearing bush, respectively.

Since it should also be possible to cost-efficiently produce the rotor unit in large quantities, however, the plain bearing bush is produced of a suitable material by means of sintering, transfer moulding or injection moulding and mechanically processed or machined in order to comply with the required tolerances of the bearing surfaces of the plain bearing bush. The plain bearing bush is then placed into a mould and a polymeric material, which typically differs from the material of the plain bearing bush, is injection-moulded around this plain bearing bush. For example, an impeller and an armature of the thusly designed rotor can be formed on the plain bearing bush in this production step.

In known production methods, it is disadvantageous that the transfer moulding process and the injection moulding process are associated with broad tolerance ranges depending on the materials used. In addition, this method does not allow the production of a sufficiently cylindrical bearing bore in the plain bearing bush, which is why a slightly larger inside diameter of the bearing bore is intentionally produced in a central region of the plain bearing bush. However, an internal mandrel of the mould used for this purpose then requires forced demoulding, which negatively affects the functional characteristics such as the inside diameter and dimensional and positional tolerances. Another disadvantage can be seen in that the required length tolerance requires postprocessing of the one-piece plain bearing bush. Machining of at least a length of the plain bearing bush and, if applicable, the bore is required in order to comply with the desired tolerances required for a long service life.

The present invention therefore is based on the objective of proposing a method for producing a rotor unit, a rotor unit for a canned motor and a pump with a rotor unit, which respectively allow a cost-efficient production.

### SUMMARY

This objective is attained by means of a method with the characteristics of claim 1 or 2, a rotor unit with the characteristics of claim 22, a bearing unit with the characteristics of claim 23 and a pump with the characteristics of claim 24.

In the inventive method for producing a rotor unit, the rotor unit is realized with a rotor and a plain bearing bush for the rotatable arrangement of the rotor on a spindle, wherein the plain bearing bush is placed into a mould, wherein the rotor is produced by attaching a polymeric material to the plain bearing bush in the mould by means of a transfer moulding process or injection moulding process, wherein the plain bearing bush is composed of a first bush section and a second bush section that is connected to the first bush section, wherein the bush sections are placed into the mould, and wherein the polymeric material is attached to the bush sections.

In the inventive method for producing a bearing unit, the bearing unit is realized with a bearing housing and a plain bearing bush for the rotatable arrangement of a spindle of a rotor, wherein the plain bearing bush is placed into a mould, wherein the bearing housing is produced by attaching a polymeric material to the plain bearing bush in the mould by means of a transfer moulding process or injection moulding process, wherein the plain bearing bush is composed of a first bush section and a second bush section that is connected to the first bush section, wherein the bush sections are placed into the mould, and wherein the polymeric material is attached to the bush sections.

The plain bearing bush therefore is composed of at least two parts, wherein the first bush section is directly or indirectly connected to the second bush section. This is simply realized by placing the respective bush sections into the mould, e.g. on a mandrel. After the bush sections have been placed into the mould, the polymeric material is introduced into the mould by means of a transfer moulding process or injection moulding process and respectively fixed on the plain bearing bush or the bush sections by curing. The injected polymeric material thereby respectively forms the rotor of the rotor unit or the bearing housing of the bearing unit. Since the plain bearing bush is composed of at least two parts, it is possible to produce the respective bush sections independently of one another. In addition, an internal mandrel no longer has to be realized in a crowned manner and pulled out of the plain bearing bush. In fact, an internal mandrel may now have a straight shoulder, which ensures that the respective bush section only comes in contact with the spindle at the desired locations. Consequently, special postprocessing of bearing bores in the respective bush sections is no longer required. Furthermore, the first and the second bush section can then be positioned relative to one another in the mould such that a desired length of the plain bearing bush is adjusted. Machining of the thusly produced plain bearing bush can thereby also be eliminated such that the production costs of a rotor unit or bearing unit can be significantly reduced.

The first bush section may form a first radial bearing surface on a first axial end of the plain bearing bush and the second bush section may form a second radial bearing surface on a second axial end lying opposite of the first end. Accordingly, the plain bearing bush may on its ends form a respective bearing surface, which can come in contact with a spindle, within a bearing bore in the plain bearing bush. In this case, the bearing bore can have a comparatively larger inside diameter between the respective bearing surfaces such that a gap is formed between the spindle and the plain bearing bush or the respective bush section. Consequently, only the respective ends of the plain bearing bush have to be produced such that they lie within a dimensional tolerance. In this respect, it is also particularly advantageous that the radial bearing surfaces are in principle realized independently of one another because the respective bearing surface can adapt its position relative to the spindle. The adaptation may take place when the bush section is placed into the mould, e.g. on a mandrel that has the shape of the spindle. In this case, it is furthermore possible to realize the bush sections and therefore also the shaft used with different inside diameters, for example, in order to adapt the bush sections to bearing forces, a sliding speed or a structural space. An angular arrangement of the bearing surface transverse to the spindle, which occurs in one-piece plain bearing bushes according to the prior art, is thereby prevented. All in all, the service life of the plain bearing bush and therefore of the respective rotor unit or bearing unit can thereby also be prolonged.

Furthermore, the first bush section and/or the second bush section may be formed with an axial bearing surface by the respective axial ends. In this case, it is also possible to precisely position the respective rotor unit or bearing unit on a spindle in the axial direction. For example, an axial contact surface for contacting the axial bearing surface may be formed on the spindle. The plain bearing bush may comprise a connecting section, by means of which the first bush section and the second bush section are connected to one another. The connecting section may be realized in the form of an additional component of the rotor unit. For example, the connecting section may be a sleeve that is fixed on the first bush section and the second bush section. In this case, the insertion of the connecting section also makes it possible to prevent the polymeric material of the rotor or the bearing housing from reaching bearing surfaces of the bush sections during its injection into the mould. The connecting section preferably forms a gap between the spindle and the plain bearing bush. Furthermore, a length of the plain bearing bush can be varied as needed by means of the connecting section such that the bush sections can in principle be realized identically and the production therefore can be additionally simplified.

Alternatively, the first bush section and/or the second bush section may form a connecting section, by means of which the first bush section and the second bush section are connected to one another. Accordingly, the connecting section may be formed by one of the bush sections, as well as by both bush sections. In this case, the connecting section is formed on a bush section or both bush sections such that that a clearance between the bush sections is bridged by the connecting section. This likewise makes it possible to prevent polymeric material from reaching bearing surfaces of the bush sections during its injection into the mould. The integral design of the connecting section with the bush section or the bush sections makes it possible to realize the plain bearing bush without an additional component. Furthermore, the connecting section may also be realized in such a way that a length of the plain bearing bush can be varied within defined limits.

The connecting section may be realized with such an inside diameter that a gap is formed with respect to the spindle. The connecting section particularly may be realized in a sleeve-shaped manner and have such an inside diameter that a radial gap is formed between the connecting section and the spindle. In this case, the plain bearing bush particularly can be realized with respective radial bearing surfaces on opposite ends of the plain bearing bush. Consequently, only the bearing surfaces have to be realized centrically relative to the spindle rather than the entire bearing bore of the plain bearing bush.

The plain bearing bush may be encased, preferably completely enclosed radially, by the polymeric material. In this way, the plain bearing bush can be integrally and/or positively connected to the rotor or the bearing housing, respectively. A relative position of the respective bush sections can be fixed during the transfer moulding process or the injection moulding process by curing the polymeric material.

A connecting fit, which allows a relative motion between the bush sections in the axial direction, may be produced between the first bush section and the second bush section. The connecting fit may be produced between a bore and a shaft, wherein the bore is formed on one bush section and the shaft is formed on the other bush section. The connecting fit then allows a relative motion between the bush sections in the axial direction such that the bush sections can during the placement into the mould, e.g. on a mandrel, be positioned in such a way that a desired length of the plain bearing bush is achieved.

The connecting fit may be designed with an inside diameter and an outside diameter on the bush sections, wherein the connecting fit may in this case be realized tight with respect to the polymeric material. The connecting fit accordingly forms a seal that prevents the polymeric material from passing through the connecting fit during its injection into the mould. In this way, no polymeric material can reach the respective bearing surfaces of the bush sections.

The first bush section and the second bush section may be designed and arranged in the mould in such a way that a radial gap is at least sectionally formed between the first bush section and the second bush section, wherein the polymeric material can penetrate into the radial gap during the transfer moulding or injection moulding process. The radial gap ensures more precise positioning of the bush sections relative to one another, wherein the bush sections of the finished rotor unit or bearing unit are prevented from being pushed together because cured polymeric material is located in the radial gap.

Nevertheless, a relative motion between the bush sections in the axial direction against respective inner surfaces of the mould can be realized by means of an injection pressure during the transfer moulding or injection moulding process. This effect particularly can be achieved in that a radial gap, into which the polymeric material can penetrate, is formed between the bush sections. The injection pressure can act upon respective axial faces of the bush sections, which lie opposite of one another and form the radial gap, and press apart these bush sections in the axial direction in such a way that the gap is increased and the bush sections are pressed against the respective inner surfaces of the mould. In this way, the length of the plain bearing bush can be realized even truer to size without requiring any machining of the plain bearing bush.

It is furthermore possible to design the mould with receptacles for a first axial end of the first bush section and a second axial end of the second bush section, wherein the bush sections can be inserted into the respective receptacles, and wherein the receptacles can seal the axial ends with respect to the polymeric material during the transfer moulding or injection moulding process. For example, the respective receptacle may be realized in the form of a blind bore, into which the respective bush section is inserted. It is important to design the receptacles in such a way that the polymeric material is unable to respectively reach axial ends of the bush sections or axial bearing surfaces of the bush sections during its injection into the mould.

The rotor or the bearing housing may be respectively made of a fiber-reinforced polymeric material. The fibers used may consist of carbon fibers or glass fibers, preferably in the form of short fibers. Short fibers may have a length between a few millimeters and 2 cm. Long fibers may alternatively also be used, for example when using partially preformed moulding materials.

A thermosetting polymer, preferably phenolic resin, epoxy resin, polyester resin or polycyclopentadiene resin, or a thermoplastic polymer, preferably polypropylene, polyphenylene sulfide or polyetheretherketone, may be used as polymeric material.

The bush sections may be made of carbon, preferably of graphite, graphite with phenolic resin impregnation, a carbonized, graphite-filled phenolic resin compound, fiber-reinforced polymer or ceramic. Furthermore, gap dimensions between the spindle and a plain bearing formed by the plain bearing bush can be adapted to thermal coefficients of expansion and a water absorption or swelling behavior of the materials under operating conditions. For example, hydrophobic additives or postprocessing of the friction partners, e.g. by means of silicones, may be used for reducing a water absorption and a swelling behavior.

Consequently, an additional filler in the form of graphite, molybdenum sulfide, tungsten disulfide, polytetrafluoroethylene, glass spheres and/or mineral additives may be added to the polymeric material of the bush sections. The addition of another filler particularly makes it possible to achieve a further improvement of a friction value. In this case, a starting resistance of the rotor unit may be comparatively low after a prolonged standstill of a pump. However, the bush sections may also be made of different materials. In this way, the bush sections can be optimally adapted to a respective stress of a bearing surface of a bush section. For example, a bush section located in the region of an impeller of the rotor unit may have different material properties or tribological properties than a bush section located in the region of an armature of the rotor unit. The choice of different materials for the respective bush sections makes it possible to optimize a friction behavior of the plain bearing bush such that a prolonged service life of the respective rotor unit or bearing unit is achieved.

The first bush section may be produced by means of machining and the second bush section may be produced by means of a transfer moulding or injection moulding process or vise versa. One of the bush sections may be machined on bearing surfaces after its production in order to achieve particularly sound sliding properties and a desired clearance fit between the spindle and the bush section. In this context, machining refers to material removal of any type, e.g. by means of turning, grinding or polishing. This type of machining makes it possible to significantly reduce a roughness of the plain bearing bush or the bush section on the bearing surfaces such that improved sliding properties can be achieved.

The plain bearing bush may be designed with a length-diameter ratio of 5:1 or greater. Accordingly, a length of the plain bearing bush may be significantly greater than an inside diameter of the plain bearing bush.

A permanent magnet or a cage winding of the rotor unit or the bearing unit may be placed into the mould and joined with the rotor or the bearing housing in the mould by means of the transfer moulding process or the injection moulding process. In this case, a permanent magnet or a cage winding no longer has to be pressed on or bonded to the plain bearing bush or the rotor. In this way, the permanent magnet or the cage winding can be integrally and/or positively connected to the rotor or the bearing housing in an inseparable manner.

The permanent magnet or the cage winding also may be encased, preferably completely enclosed, by the polymeric material. According to the prior art, permanent magnets or cage windings on the respective rotor are additionally encapsulated in order to protect these permanent magnets or cage windings from a medium to be conveyed. This additional process step also can be eliminated because the permanent magnet or the cage winding can already be encased or enclosed by the polymeric material during the production of the rotor within the mould such that the permanent magnet or the cage winding may be completely embedded in the material of the rotor. The receptacle, into which the permanent magnet or the cage winding is simply inserted, may alternatively also be formed on the rotor or the bearing housing, wherein the receptacle may form an enclosure in this case. The rotor or the bearing housing also may be joined with the permanent magnet in the mould, wherein the permanent magnet may be made of a thermoplastic or thermosetting magnetic compound. In addition, the permanent magnet can also be magnetized in a mould. It is furthermore possible to simultaneously produce the respective rotor or bearing housing and the permanent magnet in the mould by means of a two-component injection moulding process.

The inventive rotor unit for a canned motor is realized with a rotor and a plain bearing bush for the rotatable arrangement of the rotor on a spindle, wherein the rotor is produced by attaching a polymeric material to the plain bearing bush in a mould by means of a transfer moulding process or injection moulding process, wherein the plain bearing bush is composed of a first bush section and a second bush section that is connected to the first bush section, and wherein the polymeric material is attached to the bush sections. With respect to the advantages of the inventive rotor unit, we refer to the description of the advantages of the inventive method.

Other advantageous embodiments of a rotor unit result from the characteristics of the dependent claims, which refer to claim 1.

The inventive bearing unit for a canned motor is realized with a bearing housing and a plain bearing bush for the rotatable arrangement of a spindle of a rotor, wherein the bearing housing is produced by attaching a polymeric material to the plain bearing bush in a mould by means of a transfer moulding process or injection moulding process, wherein the plain bearing bush is composed of a first bush section and a second bush section that is connected to the first bush section, and wherein the polymeric material is attached to the bush sections.

Other advantageous embodiments of a bearing unit result from the characteristics of the dependent claims, which refer to claim 2.

The inventive pump comprises an inventive rotor unit or bearing unit. In this respect, advantageous embodiments of a pump also result from the characteristics of the dependent claims, which respectively refer to claim 1 or claim 2.

### BRIEF DESCRIPTION OF THE DRAWINGS

An embodiment of the invention is described in greater detail below with reference to the attached drawings.

In these drawings:

FIG. 1 shows a longitudinal section through a rotor unit according to the prior art; and

FIG. 2 shows a longitudinal section through a plain bearing bush in a mould.

### DETAILED DESCRIPTION

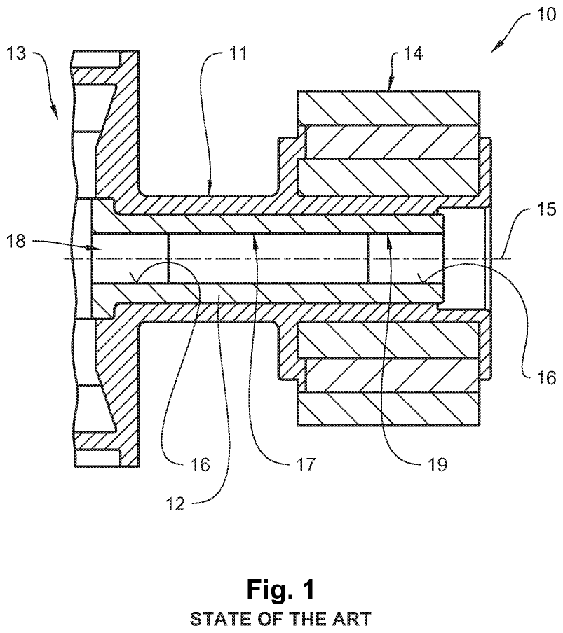

FIG. 1 shows a rotor unit 10 according to the prior art, wherein the rotor unit 10 is composed of a rotor 11 and a plain bearing bush 12. The rotor 11 consists of a polymeric material, which was attached to the plain bearing bush 12 in a not-shown mould by means of a transfer moulding process or injection moulding process. The rotor 11 forms an impeller 13 and comprises an armature 14, which forms part of a not-shown canned motor for driving the impeller 13. The rotor unit 10 can be placed on a not-shown spindle in order to thereby rotate about the rotational axis 15 of the rotor unit 10. In the process, radial bearing surfaces 16 of the plain bearing bush 12 come in contact with the spindle, wherein an inside diameter 17 of a bearing bore 18 of the plain bearing bush 12 lying between the radial bearing surfaces 16 is larger than an inside diameter 19 of the radial bearing surfaces 16. A gap, which is not visible in this figure, can thereby be formed between the not-shown spindle and the inside diameter 17. The plain bearing bush 12 is produced in one piece by means of a transfer moulding process or injection moulding process, wherein the material of the plain bearing bush 12 differs from the polymeric material of the rotor 11.

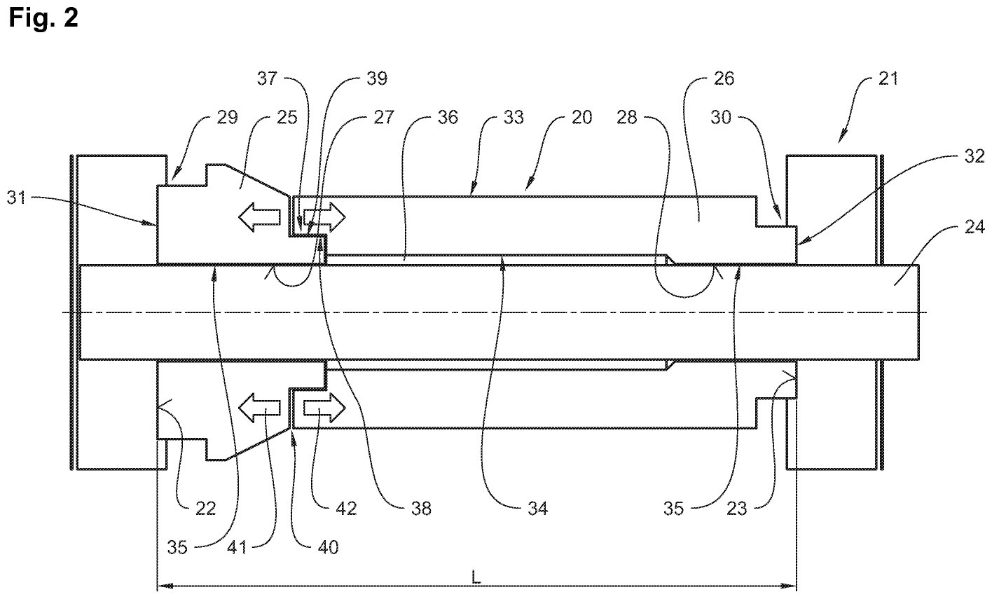

FIG. 2 shows a longitudinal section through a plain bearing bush 20 in a mould 21. The plain bearing bush 20 can be encased with a polymeric material in the mould 21, for example in order to produce the rotor shown in FIG. 1. The schematically indicated mould 21 has opposite inner surfaces 22 and 23 and comprises a mandrel 24, on which the plain bearing bush 20 is placed. The plain bearing bush 20 is composed of a first bush section 25 and a second bush section 26, wherein the first bush section 25 is connected to the second bush section 26. In this case, the first bush section 25 forms a first radial bearing surface 27 and the second bush section 26 forms a second radial bearing surface 28. A first axial bearing surface 31 is formed on a first axial end 29 of the first bush section 25 and a second axial bearing surface 32 is formed on a second axial end 30 of the second bush section 26. The first axial bearing surface 31 and the second axial bearing surface 32 tightly abut on the respective inner surfaces 22 and 23 of the mould. In this case, a distance between the inner surfaces 22 and 23 of the mould essentially corresponds to a length L of the plain bearing bush 20.

The second bush section 26 forms a connecting section 33 with an inside diameter 34, which is larger than an inside diameter 35 of the radial bearing surfaces 27 and 28 such that a gap 36 is formed on the mandrel 34 in the connecting section 33. In addition, a connecting fit 37 is produced between the first bush section 25 and the second bush section 26 with an inside diameter 38 on the second bush section 26 and an outside diameter 39 on the first bush section 25. The connecting fit 37 allows a relative motion between the bush sections 25 and 26, wherein the connecting fit 37 prevents polymeric material from passing into the gap 36 during its injection into the mould 21.

A radial gap 40, into which the polymeric material penetrates during the transfer moulding or injection moulding process, furthermore is formed between the first bush section 25 and the second bush section 26 in the region of the connecting fit 37. As a result, the first bush section 25 and the second bush section 26 are respectively pressed in the direction of the arrows 41 and 42 such that the first axial bearing surface 31 and the second axial bearing surface 32 are pressed against the respective inner surfaces 22 and 23 of the mould. In this case, mechanical processing of the plain bearing bush 20 is no longer required after the polymeric material of the rotor has cured. A potential shrinkage can be ignored during the production of the bush sections 25 and 26 because the already finished bush sections 25 and 26 are adapted to the length L of the plain bearing bush 20 in the mould 21. Nevertheless, it is possible to choose different materials for the bush sections 25 and 26 in order to adapt the bush sections 25 and 26 even better to a potential load. In the plain bearing bush 20, the first bush section 25 is arranged in the region of a not-shown impeller of the rotor.

1. A method for producing a rotor unit, wherein the rotor unit is realized with a rotor and a plain bearing bush (20) for the rotatable arrangement of the rotor on a spindle, wherein the plain bearing bush is placed into a mould (21), and wherein the rotor is produced by attaching a polymeric material to the plain bearing bush in the mould by means of a transfer moulding process or injection moulding process,
characterized in
that the plain bearing bush is composed of a first bush section (25) and a second bush section (26) that is connected to the first bush section, wherein the bush sections are placed into the mould, and wherein the polymeric material is attached to the bush sections.

2. A method for producing a bearing unit, wherein the bearing unit is realized with a bearing housing and a plain bearing bush for the rotatable arrangement of a spindle of a rotor, wherein the plain bearing bush is placed into a mould, and wherein the bearing housing is produced by attaching a polymeric material to the plain bearing bush in the mould by means of a transfer moulding process or injection moulding process,
characterized in
that the plain bearing bush is composed of a first bush section and a second bush section that is connected to the first bush section, wherein the bush sections are placed into the mould, and wherein the polymeric material is attached to the bush sections.

3. The method according to claim 1,
characterized in
that first bush section (25) forms a first radial bearing surface (27) on a first axial end (29) of the plain bearing bush (20) and the second bush section (26) forms a second radial bearing surface (28) on a second axial end (30) lying opposite of the first end.

4. The method according to claim 3,
characterized in
that the first bush section (25) and/or the second bush section (26) are formed with an axial bearing surface (31, 32) on the respective axial ends (29, 30).

5. The method according to claim 1,
characterized in
that the plain bearing bush comprises a connecting section, by means of which the first bush section and the second bush section are connected to one another.

6. The method according to claim 1,
characterized in
that the first bush section (25) and/or the second bush section (26) form a connecting section (33), by means of which the first bush section and the second bush section are connected to one another.

7. The method according to claim 5,
characterized in
that the connecting section (33) is realized with such an inside diameter (34) that a gap (36) is formed with respect to the spindle.

8. The method according to claim 1,
characterized in
that the plain bearing bush (20) is encased, preferably completely enclosed radially, by the polymeric material.

9. The method according to claim 1,
characterized in
that a connecting fit (37), which allows a relative motion between the bush sections in the axial direction, is produced between the first bush section (25) and the second bush section (26).

10. The method according to claim 9,
characterized in
that the connecting fit (37) is designed with an inside diameter (38) and an outside diameter (39) on the bush sections (25, 26), wherein the connecting fit is realized tight with respect to the polymeric material.

11. The method according to claim 1,
characterized in
that the first bush section (25) and the second bush section (26) are designed and arranged in the mould (21) in such a way that a radial gap (40) is at least sectionally formed between the first bush section and the second bush section, wherein the polymeric material can penetrate into the radial gap during the transfer moulding or injection moulding process.

12. The method according to claim 1,
characterized in
that a relative motion between the bush sections (25, 26) in the axial direction against respective inner surfaces (22, 23) of the mould (21) is realized by means of an injection pressure during the transfer moulding or injection moulding process.

13. The method according to claim 1,
characterized in
that the mould (21) is designed with receptacles for a first axial end (29) of the first bush section (25) and a second axial end (30) of the second bush section (26), wherein the bush sections can be inserted into the respective receptacles, and wherein the receptacles seal the axial ends with respect to the polymeric material during the transfer moulding or injection moulding process.

14. The method according to claim 1,
characterized in
that the rotor or the bearing housing is made of a fiber-reinforced polymeric material.

15. The method according to claim 14,
characterized in
that a thermosetting polymer, preferably phenolic resin, epoxy resin, polyester resin or polycyclopentadiene resin, or a thermoplastic polymer, preferably polypropylene, polyphenylene sulfide or polyetheretherketone, is used as polymeric material.

16. The method according to claim 1,
characterized in
that the bush sections (25, 26) are made of carbon, preferably of graphite, graphite with phenolic resin impregnation, a carbonized, graphite-filled phenolic resin compound, fiber-reinforced polymer or ceramic.

17. The method according to claim 16,
characterized in
that an additional filler in the form of graphite, molybdenum sulfide, tungsten disulfide, polytetrafluoroethylene, glass spheres and/or mineral additives is added to the polymeric material of the bush sections (25, 26).

18. The method according to claim 1,
characterized in
that the bush sections (25, 26) are made of different materials.

19. The method according to claim 1,
characterized in
that the first bush section (25) is produced by means of machining and the second bush section (26) is produced by means of a transfer moulding or injection moulding process.

20. The method according to claim 1,
characterized in
that the plain bearing bush (20) is designed with a length-diameter ratio of 5:1 or greater.

21. The method according to claim 1,
characterized in
that a permanent magnet or a cage winding of the rotor unit or the bearing unit is placed into the mould (21) and joined with the rotor or the bearing housing in the mould by means of the transfer moulding process or the injection moulding process.

22. A rotor unit for a canned motor, wherein the rotor unit is realized with a rotor and a plain bearing bush (20) for the rotatable arrangement of the rotor on a spindle, and wherein the rotor is produced by attaching a polymeric material to the plain bearing bush in a mould (21) by means of a transfer moulding process or injection moulding process,
characterized in
that the plain bearing bush is composed of a first bush section (25) and a second bush section (26) that is connected to the first bush section, wherein the polymeric material is attached to the bush sections.

23. A bearing unit for a canned motor, wherein the bearing unit is realized with a bearing housing and a plain bearing bush for the rotatable arrangement of a spindle of a rotor, and wherein the bearing housing is produced by attaching a polymeric material to the plain bearing bush in a mould by means of a transfer moulding process or injection moulding process,
characterized in
that the plain bearing bush is composed of a first bush section and a second bush section that is connected to the first bush section, wherein the polymeric material is attached to the bush sections.

24. A pump with a rotor unit according to claim 22.
